(19) United States
(12) Patent Application Publication
(10) Pub. No.: US 2024/0383333 A1
(43) Pub. Date: Nov. 21, 2024

(54) COCKPIT DISPLAY SYSTEM

(71) Applicant: AUO Corporation, Hsinchu (TW)

(72) Inventors: Yu-Chi Chen, Hsinchu (TW); Chi-Yu Liu, Hsinchu (TW); Chia-Sheng Cheng, Hsinchu (TW)

(73) Assignee: AUO Corporation, Hsinchu (TW)

(21) Appl. No.: 18/391,424

(22) Filed: Dec. 20, 2023

Related U.S. Application Data
(60) Provisional application No. 63/467,416, filed on May 18, 2023.

(30) Foreign Application Priority Data
Nov. 10, 2023 (TW) 112143378

(51) Int. Cl. B60K 35/10; B60K 35/22; B60K 35/23

(52) U.S. Cl. CPC B60K 35/10; B60K 35/223; B60K 35/23; B60K 2360/119; B60K 2360/1438; B60K 2360/1468; B60K 2360/195; B60K 2360/782; B60K 2360/785

(57) ABSTRACT

A cockpit display system adapted to be installed in a cockpit and including a touch display, at least one head-up display, and a control unit. The touch display is disposed in a steering wheel in the cockpit and is adapted to display image information. A decorative layer of the steering wheel covers a display surface of the touch display. The at least one head-up display is adapted for display on a see-through window of the cockpit. The control unit is electrically connected to the touch display and the at least one head-up display. The control unit is adapted to display the image information on at least one of the touch display and the at least one head-up display according to a touch action performed on the touch display. Another cockpit display system is also provided.

### CROSS-REFERENCE TO RELATED APPLICATION

This application claims the priority benefit of U.S. provisional application Ser. No. 63/467,416, filed on May 18, 2023 and Taiwan application serial no. 112143378, filed on Nov. 10, 2023. The entirety of each of the above-mentioned patent application is hereby incorporated by reference herein and made a part of this specification.

### BACKGROUND

### Technical Field

The disclosure relates to a display system, and in particular, relates to a cockpit display system.

### Description of Related Art

The related applications of displays in the automotive field are gradually emerging as display technology becomes more mature. In recent years, in some of the high-end cars on the market, conventional dashboards, rear-view mirrors, or center consoles have gradually been replaced by flat or curved displays. Despite the above, most of the currently-available steering wheels are still equipped with several physical buttons for the execution of different functions. The arrangement of these functional buttons not only lowers the aesthetics of the appearance of the steering wheel, but also makes the operation less intuitive. Further, a driver often has to lower his/her head to confirm the corresponding function options on the dashboard to make adjustments, which makes the driver easily distracted and affects driving safety.

### SUMMARY

The disclosure provides a cockpit display system allowing information to be conveniently presented and operation to be intuitively executed.

The disclosure provides a cockpit display system providing enhanced immersive feeling in image display.

The disclosure provides a cockpit display system adapted to be installed in a cockpit and including a touch display, at least one head-up display, and a control unit. The touch display is disposed in a steering wheel in the cockpit and is adapted to display image information. A decorative layer of the steering wheel covers a display surface of the touch display. The at least one head-up display is adapted for display on a see-through window of the cockpit. The control unit is electrically connected to the touch display and the at least one head-up display. The control unit is adapted to display the image information on at least one of the touch display and the at least one head-up display according to a touch action performed on the touch display.

The disclosure further provides a cockpit display system adapted to be installed in a cockpit and including at least one head-up display, a transparent display, and a control unit. The at least one head-up display is adapted for display on a see-through window of the cockpit. The transparent display is disposed in the see-through window of the cockpit and overlaps the at least one head-up display. The control unit is electrically connected to the touch display and the at least one head-up display. The control unit is adapted to display an image frame on the transparent display and the at least one head-up display in a tiled manner.

To sum up, in the cockpit display system provided by an embodiment of the disclosure, the touch display installed in the steering wheel may be used to replace the multiple functional buttons on a currently-available steering wheel. Further, during operation, the control unit may display the image information on at least one of the touch display and the at least one head-up display according to the touch action performed on the touch display. In this way, the overall aesthetics of the steering wheel is improved, and the selection and setting of its control items may be more intuitive and convenient.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic three-dimensional view of a cockpit display system according to the disclosure.

FIG. 2 is a block diagram of the cockpit display system of FIG. 1.

FIG. 3A and FIG. 3B are schematic side views of an operation flow process of a steering wheel in FIG. 1 when a touch display is touched.

FIG. 4A to FIG. 4C are schematic views of a flow process of the cockpit display system in FIG. 1 operating in a first scenario.

FIG. 5 is a block diagram of the cockpit display system in FIG. 1 when the cockpit display system is wirelessly connected to a mobile device.

FIG. 6A to FIG. 6C are schematic views of the flow process of the cockpit display system in FIG. 1 operating in a second scenario.

FIG. 7A to FIG. 7B are schematic views of the flow process of the cockpit display system in FIG. 1 operating in a third scenario.

FIG. 8 is a schematic view of the cockpit display system in FIG. 1 operating in the third scenario.

FIG. 9 is a schematic view of a variation implementation of FIG. 7B.

FIG. 10A to FIG. 10B are schematic views of the flow process of the cockpit display system in FIG. 1 operating in a fourth scenario.

FIG. 11A to FIG. 11B are schematic views of the flow process of the cockpit display system in FIG. 1 operating in a fifth scenario.

### DESCRIPTION OF THE EMBODIMENTS

The terms used herein such as “about”, “approximate”, “essentially”, or “substantial” include a related value and an average within an acceptable deviation range of specific values determined by a person having ordinary skill in the art with consideration of discussed measurement and a specific number of errors related to the measurement (i.e., the limit of the measurement system). For example, “about” may mean within one or more standard deviations, or within, for example, ±30%, ±20%, ±15%, ±10%, ±5% of the stated value. Moreover, a relatively acceptable range of deviation or standard deviation may be chosen for the term “about”, “approximately”, “essentially”, or “substantially” as used herein based on measurement properties, cutting properties, or other properties, instead of applying one standard deviation across all the properties.

In the accompanying drawings, thicknesses of layers, films, panels, regions, and so on are exaggerated for clarity. It should be understood that when an element such as a layer, film, region or substrate is referred to as being “on” or “connected to” another element, it means that the element is directly on or connected to the another element, or an intervening element may be provided therebetween. In contrast, when an element is referred to as being “directly on” or “directly connected to” another element, there are no intervening elements present. As used herein, the term “connected” may refer to physical connection and/or electrical connection. Further, the “electrical connection” may be that other elements are provided between two elements.

Moreover, relative terms such as “below” or “bottom” and “above” or “top” may serve to describe the relation between one element and another element in the specification as shown in the drawings. It should also be understood that the relative terms are intended to include different orientations of a device in addition to the orientation shown in the drawings. For example, if a device in the drawings is flipped, an element originally described as being disposed “below” other elements shall be orientated to be “above” other elements. Therefore, the exemplary term “below” may cover the orientations of “below” and “above”, depending on the specific orientation of the drawings. Similarly, if a device in the drawing is flipped over, an element originally described to be located “under” or “underneath” other elements is oriented to be located “above” the other elements. Therefore, the illustrative term “on” or “below” may include orientations of “above” and “under”.

Exemplary embodiments are described herein with reference to schematic cross-sectional views illustrating idealized embodiments. Hence, variations of shapes resulting from manufacturing technologies and/or tolerances, for instance, are to be expected. Hence, the embodiments described herein should not be construed as being limited to the particular shapes of regions as illustrated herein but are to include deviations in shapes that result, for example, from manufacturing. For instance, regions shown or described as being flat may typically have rough and/or non-linear features. Besides, the acute angle as shown may be round. Therefore, the regions shown in the drawings are schematic in nature, and their shapes are not intended to show the exact shape of the regions, and are not intended to limit the scope of the claims.

Descriptions of the disclosure are given with reference to the exemplary embodiments illustrated by the accompanying drawings in detail. Wherever possible, the same reference numbers are used in the drawings and the description to refer to the same or like parts.

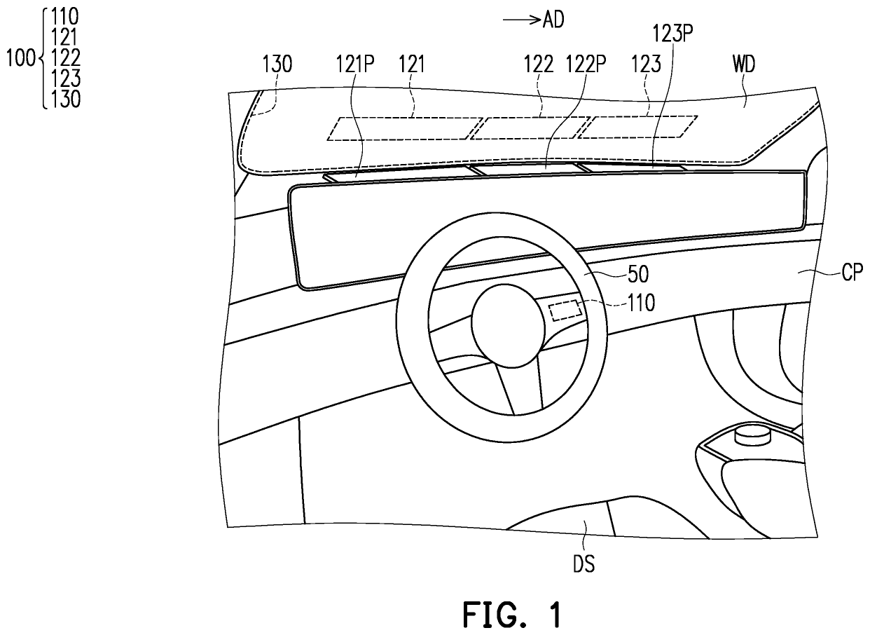

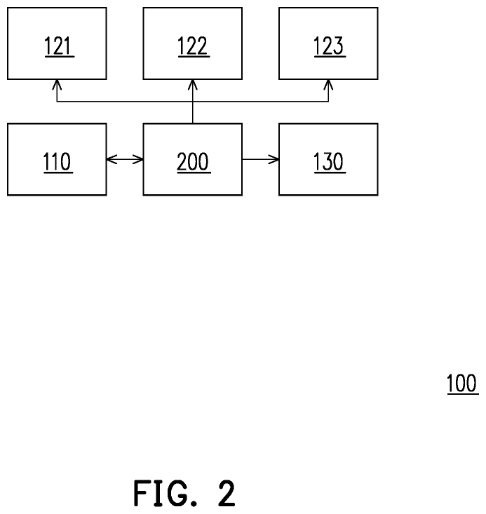

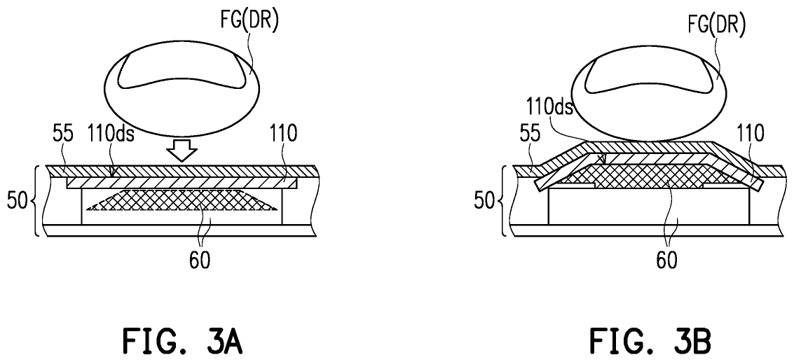

FIG. 1 is a schematic three-dimensional view of a cockpit display system according to the disclosure. FIG. 2 is a block diagram of the cockpit display system of FIG. 1. FIG. 3A and FIG. 3B are schematic side views of an operation flow process of a steering wheel in FIG. 1 when a touch display is touched. With reference to FIG. 1 and FIG. 2, a cockpit display system 100 adapted to be installed in a cockpit CP may optionally include a touch display 110, a first head-up display 121, a second head-up display 122, a third head-up display 123, and a transparent display 130. It should be noted that in this embodiment, although the number of the head-up displays is exemplified by taking three as an example, it does not mean that the disclosure is limited thereto. In other embodiments, the number of the head-up displays may be adjusted according to different application scenarios.

In this embodiment, the cockpit CP is, for example, a car cockpit, but is not limited thereto. In other embodiments, the cockpit may also be a simulator cockpit or a computer cockpit. The cockpit CP may be provided with a driver's seat DS and a steering wheel 50 arranged in front of the driver's seat DS. It is particularly noted that the touch display 110 is disposed in the steering wheel 50, and a decorative layer 55 of the steering wheel 50 covers a display surface 110ds of the touch display 110 (as shown in FIG. 3A). More specifically, the touch display 110 of this embodiment is a touch screen hidden inside the steering wheel 50.

When the touch display 110 is touched by a finger FG of a driver DR, the display surface 110ds of the touch display 110 is adapted to be deformed and raised toward the decorative layer 55 of the steering wheel 50 (as shown in FIG. 3B). In this embodiment, the deforming and raising of the touch display 110 may be implemented by triggering an actuating mechanism 60 inside the steering wheel 50, but it is not limited thereto. Therefore, the touch display 110 of this embodiment has stretchable or flexible characteristics. For instance, the touch display 110 may be formed by a plurality of light-emitting units (not shown) with self-luminous characteristics and a plurality of signal lines (not shown) connected in series to the light-emitting units. Each light-emitting unit may include a pixel circuit (not shown) and at least one light-emitting element (not shown), and each signal line may be bent or stretched, but it is not limited thereto.

On the other hand, in order to allow the touch display 110 hidden under the decorative layer 55 of the steering wheel 50 to display clearly, the touch display 110 of this embodiment may also have high brightness display characteristics, but it is not limited thereto. In other embodiments, the decorative layer 55 of the steering wheel 50 may be provided with a plurality of slits in a portion overlapping the display surface 110ds of the touch display 110. These slits are in a closed state when the touch display 110 is not deformed nor raised, but the slits form larger openings when the touch display 110 is deformed and raised, so that an image frame of the touch display 110 under the decorative layer 55 can be clearly displayed.

It is particularly noted that the touch display 110 of this embodiment may be used to replace various functional buttons on a currently-available steering wheel to enhance the overall aesthetics of the steering wheel 50. For instance, the touch display 110 may be used to display image information with a functional menu, but it is not limited thereto. Further, the deformable characteristic of the touch display 110 may also enhance the tactile feedback when the driver DR operates.

In this embodiment, the first head-up display 121, the second head-up display 122, and the third head-up display 123 may be arranged side by side in an arrangement direction AD, and are adapted for display on a see-through window WD of the cockpit CP. For instance, the first head-up display 121, the second head-up display 122, and the third head-up display 123 respectively have a first light projector 121P, a second light projector 122P, and a third light projector 123P. These light projectors may be installed on a control platform of the cockpit CP and project images toward the see-through window WD.

The transparent display 130 is disposed in the see-through window WD of the cockpit CP and overlaps the first head-up display 121, the second head-up display 122, and the third head-up display 123. In this embodiment, a see-through range of the see-through window WD is generally an installation range of the transparent display 130, but it is not limited thereto.

With reference to FIG. 1 and FIG. 2 again, the cockpit display system 100 further includes a control unit 200 electrically connected to the touch display 110, the first head-up display 121, the second head-up display 122, the third head-up display 123, and the transparent display 130. In this embodiment, the control unit 200 is, for example, a cockpit domain controller (CDC) featuring high-performance computer computing capabilities and is suitable for executing a variety of algorithms to implement the function of actively adjusting the display screen. Since these displays are all driven by the same control unit 200, the information transfer between the displays is convenient and the operation is intuitive.

For instance, in this embodiment, the control unit 200 is adapted to display image information on at least one of the touch display 110, the first head-up display 121, the second head-up display 122, and the third head-up display 123 according to a touch action performed by the driver DR on the touch display 110.

Several usage scenarios of the touch display 110, the head-up displays, and the transparent display 130 of the cockpit display system 100 are to be exemplarily described in the following paragraphs.

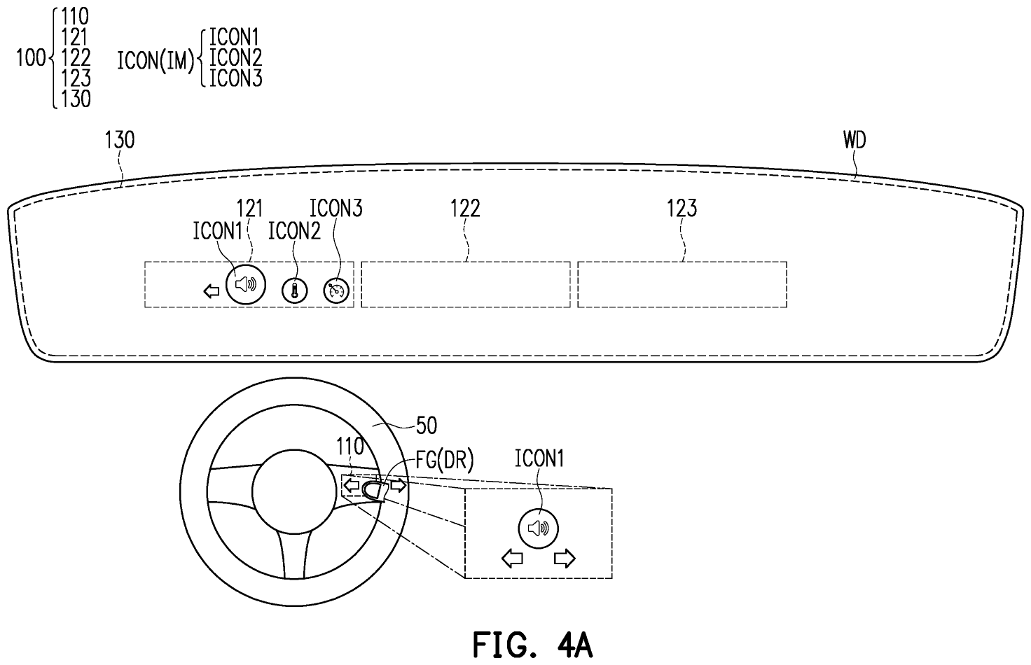

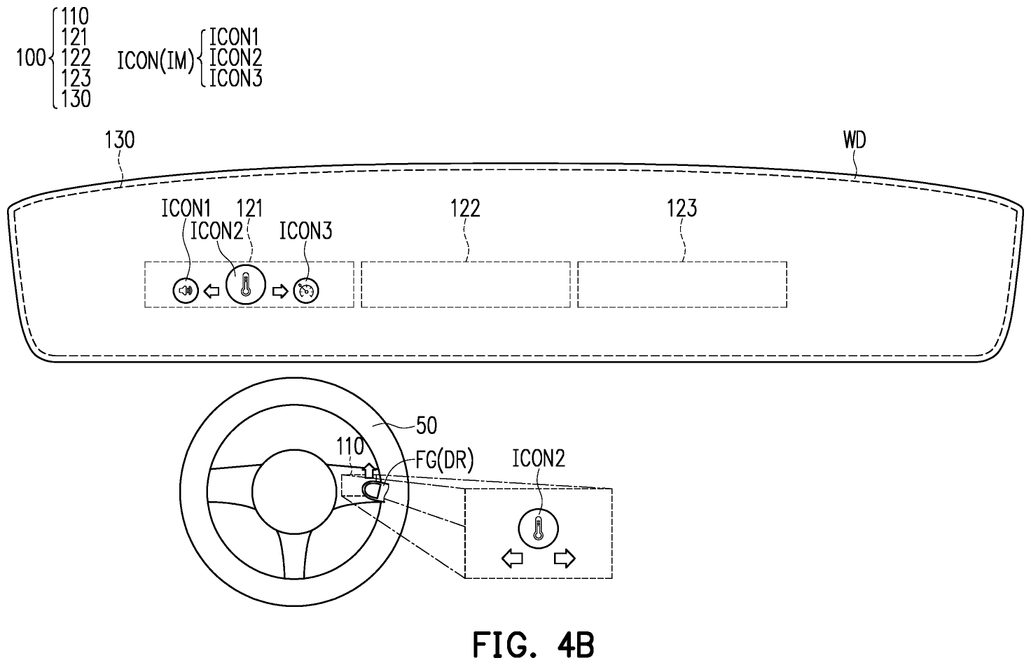

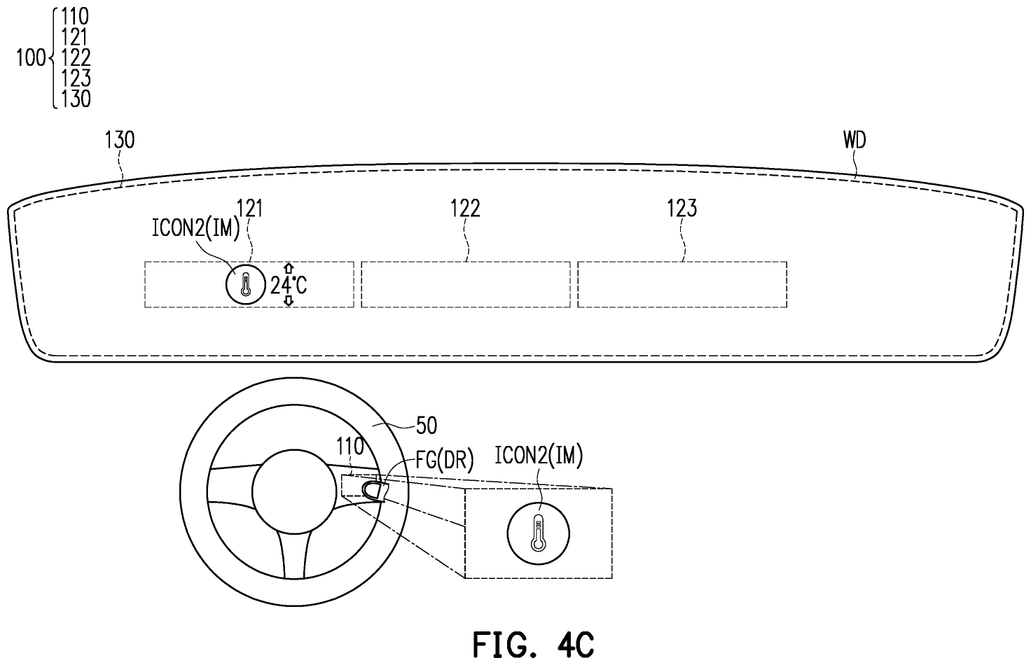

FIG. 4A to FIG. 4C are schematic views of a flow process of the cockpit display system in FIG. 1 operating in a first scenario. With reference to FIG. 2, FIG. 4A, and FIG. 4B, for instance, when the finger FG (for example, the thumb of the right hand) of the driver DR touches the touch display 110 in the steering wheel 50, the display surface 110ds of the touch display 110 is deformed and raised toward the decorative layer 55 of the steering wheel 50 (as shown in FIG. 3A and FIG. 3B). At the same time, the touch display 110 and the first head-up display 121 simultaneously display at least a portion of image information IM, but it is not limited thereto. In other embodiments, the image information IM may also be synchronously displayed on at least two of the first head-up display 121, the second head-up display 122, and the third head-up display 123 in a tiled manner.

It should be noted that in this embodiment, since a displayable screen size of the touch display 110 is smaller than that of each of the head-up display, in order to clearly present the image, the touch display 110 may synchronously display only a key portion of the image information IM presented on the head-up display. If the display size of the touch display 110 increases due to different arrangement on the steering wheel 50, the synchronous display content of the image information IM on the touch display 110 may be increased. The disclosure does not intend to limit the way of synchronous display of the touch display 110 and the head-up display.

In addition, in another embodiment, when the driver DR touches the touch display 110 in the steering wheel 50, the image information IM may only be displayed on the touch display 110. Only when the driver DR further performs a touch action of sliding the touch display 110 in a direction of the head-up displays, will the control unit 200 synchronously display the image information IM on the head-up displays.

In this embodiment, the image information IM is, for example, a functional menu including a plurality of icons ICON. The driver DR can switch and display the icons ICON of the functional menu by performing another touch action on the touch display 110. For instance, the driver DR's finger FG can slide in an arrangement direction of these icons ICONs to browse different function options of the functional menu.

It is particularly noted that during the switching and displaying process of the icons ICON, a size of a focused icon ICON is be enlarged, while the sizes of the other icons remain unchanged or reduced. As shown in FIG. 4A, when the driver DR slides an icon ICON1 representing a volume adjustment function to the center of the screen, the size of the icon ICON1 is be enlarged, while the sizes of an icon ICON2 representing a temperature adjustment function and an icon ICON3 representing a cruise control function both remain unchanged.

Similarly, when the driver DR slides the icon ICON2 to the center of the screen, the size of the icon ICON2 is enlarged, the size of the icon ICON1 slid out of the center of the screen is reduced, and the size of the remaining icon ICON3 remains unchanged, as shown in FIG. 4B.

When the driver DR wants to adjust the temperature setting of the air conditioner in the cabin CP, the driver DR can perform a touch action of sliding the touch display 110 toward the head-up displays. The control unit 200 displays the functional screen of the selected icon ICON2 on the head-up display according to this touch action, as shown in FIG. 4C. Nevertheless, the disclosure is not limited thereto. In another embodiment, the touch action for icon selection may also include sliding in a direction away from the head-up displays.

After entering the functional screen, the driver DR can adjust the air-conditioning temperature setting value by sliding up and down on the touch display 110. After completion, if the driver DR does not perform any further touch action (such as browsing the functional menu or selecting other functional icons), after waiting time predetermined by the system is exceeded, the control unit 200 can actively turn off the display screen of the touch display 110 or switch the display screen back to a standby screen. Further, the display surface 110ds returns to the undeformed state, so that the decorative layer 55 of the steering wheel 50 returns to a flat state (as shown in FIG. 3A).

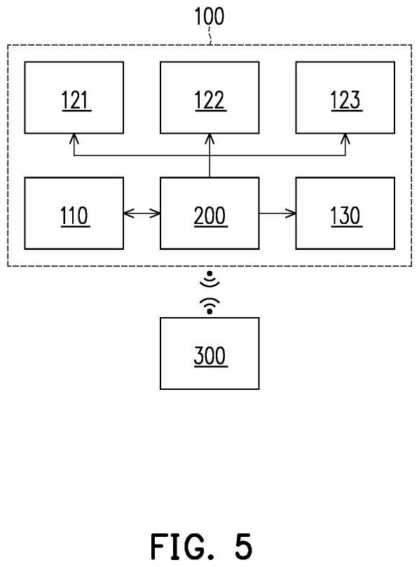

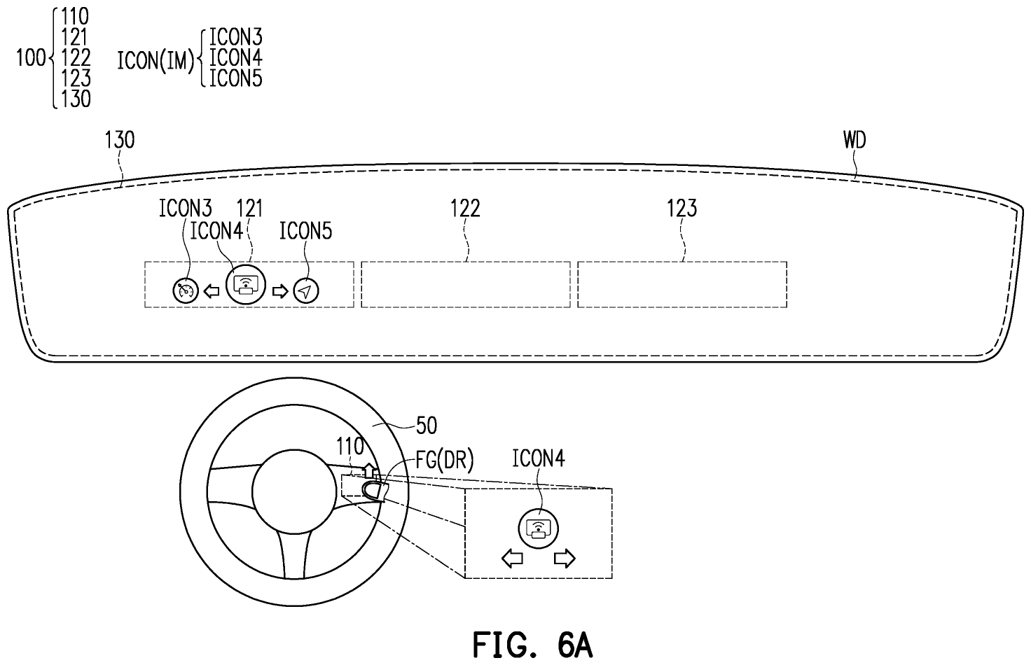

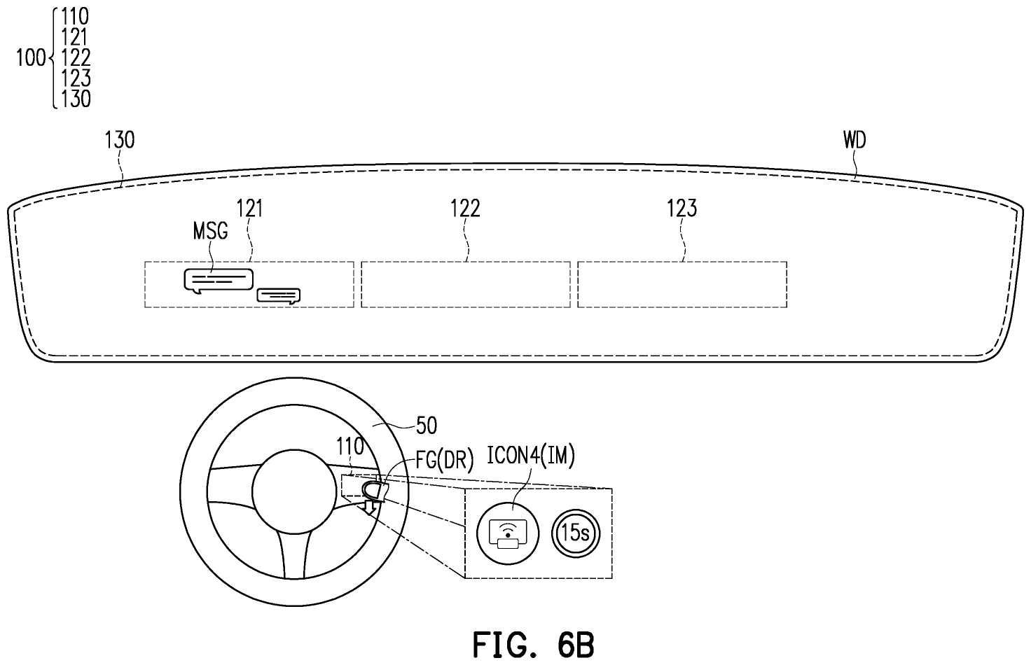

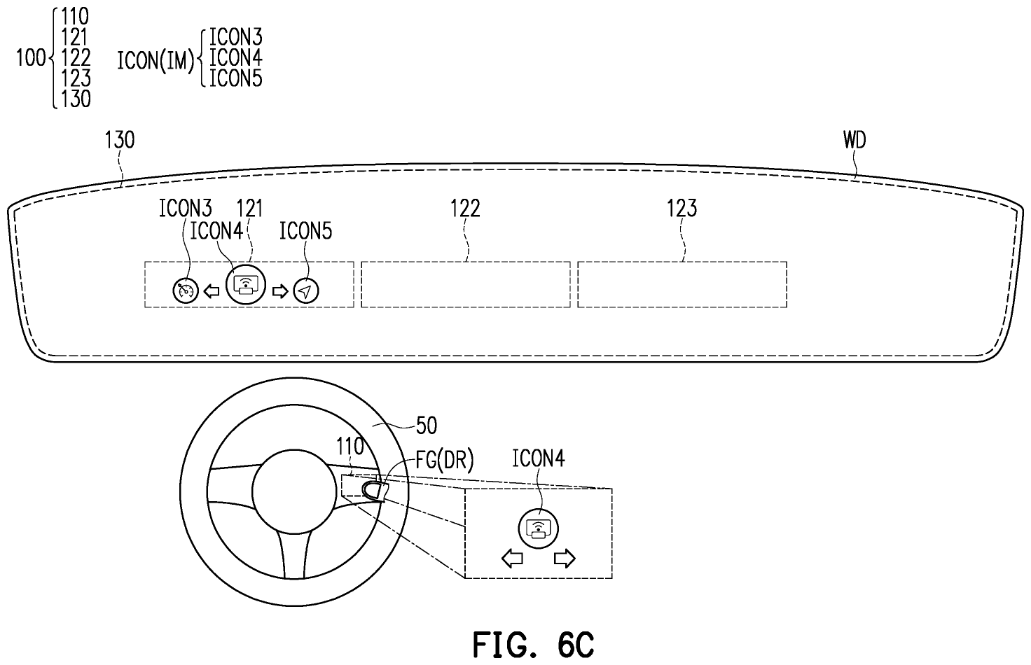

FIG. 5 is a block diagram of the cockpit display system in FIG. 1 when the cockpit display system is wirelessly connected to a mobile device. FIG. 6A to FIG. 6C are schematic views of the flow process of the cockpit display system in FIG. 1 operating in a second scenario. With reference to FIG. 5, the cockpit display system 100 of this embodiment is also adapted for wireless connection to a mobile device 300 (such as a smartphone, but not limited thereto), and an image or a message on the mobile device 300 may be projected on the head-up displays for display.

For instance, when the driver DR slides an icon ICON4 representing a projection function of the mobile device to the center of the screen (as shown in FIG. 6A), the driver DR can perform the touch action of sliding the touch display 110 toward the head-up displays to enter the functional screen corresponding to the icon ICON4. This functional screen may display a conversation message MSG (as shown in FIG. 6B) or an image screen (such as a video call screen) on the mobile device 300.

It is particularly noted that for the safety of the driver DR, the operation of this function can be limited to be executed only when the vehicle is stationary. For instance, only when the vehicle is stopped and waiting for a red light can the driver DR project the image or message on the mobile device 300 to the head-up displays for display and operation. In order to remind the driver DR how long the driver DR has to wait before the traffic lights change, the cockpit display system 100 can also use an external camera or the vehicle-to-everything to obtain the countdown seconds of the traffic lights and display the countdown seconds on the touch display 110 (as shown in FIG. 6B) or the head-up display.

When the countdown seconds of the traffic lights are lower than a predetermined number of seconds (for example, five seconds), the cockpit display system 100 automatically turns off the projection display screen of the mobile device 300 on the head-up display. Nevertheless, the disclosure is not limited thereto. With reference to FIG. 5, FIG. 6B, and FIG. 6C, when the driver DR wants to actively turn off the image projection of the mobile device 300, the driver DR can perform a touch action of sliding on the touch display 110 in the direction away from the head-up displays to exit the functional screen of the icon ICON4 and re-enter the image screen IM of the functional menu.

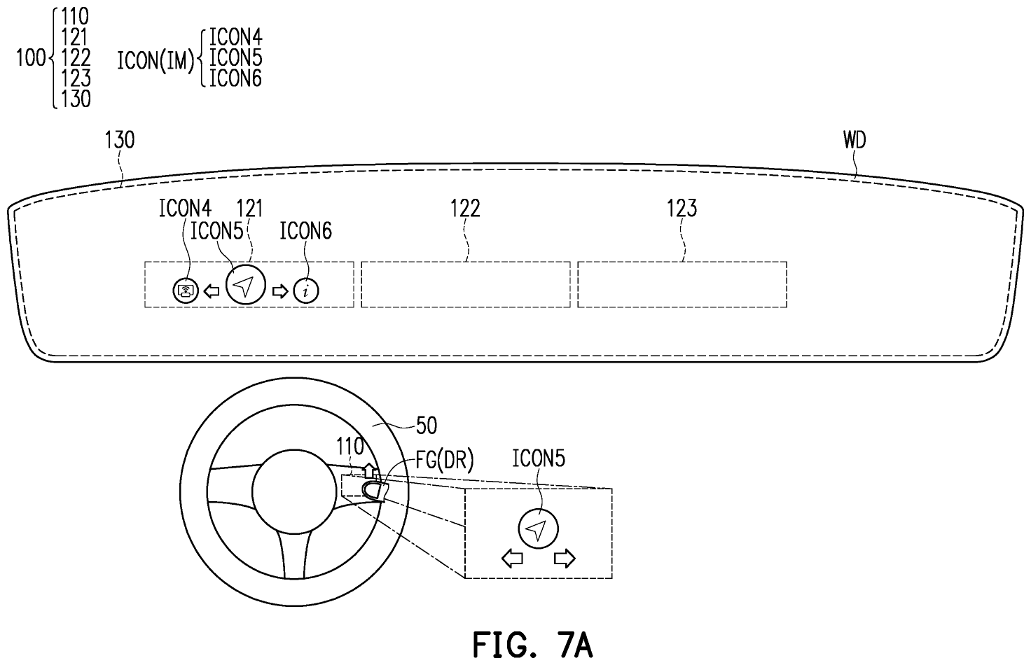

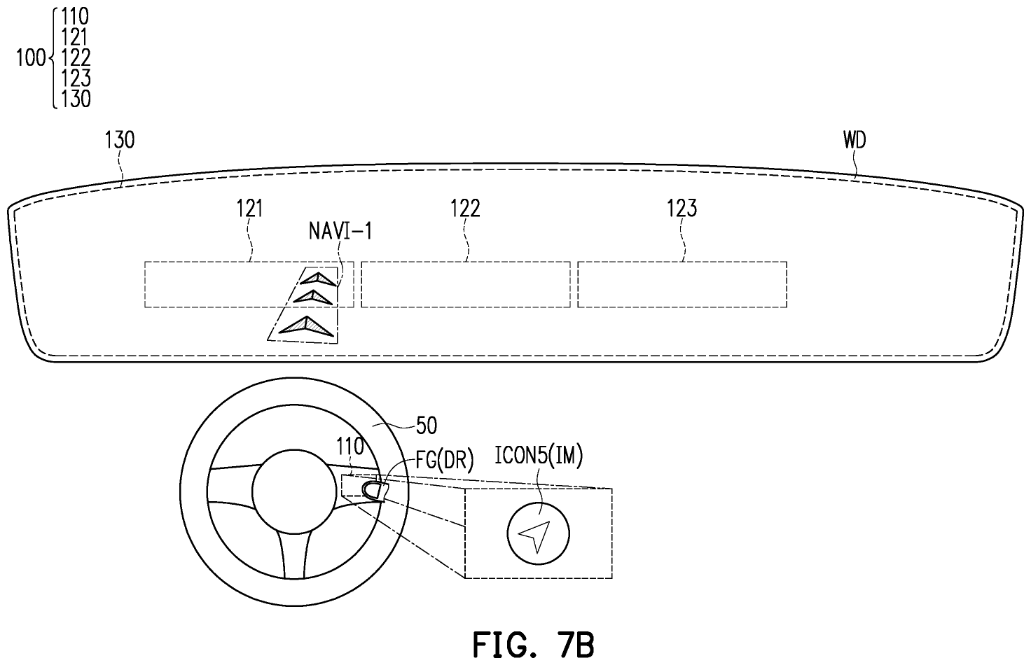

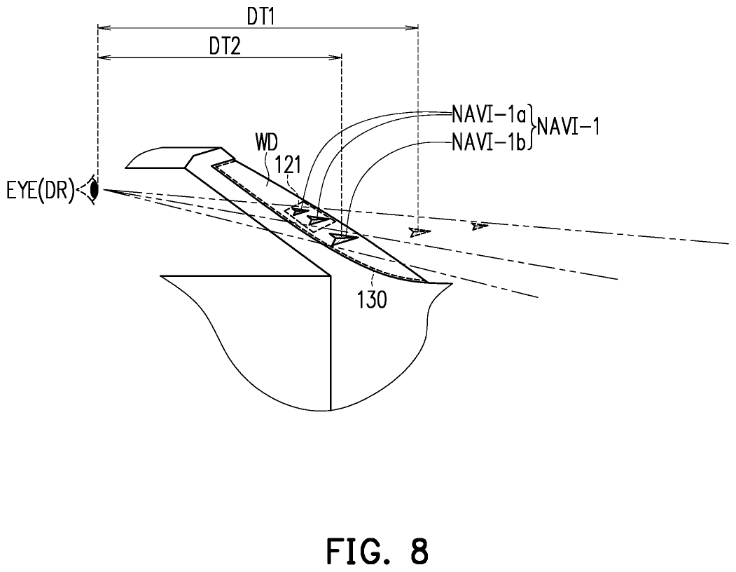

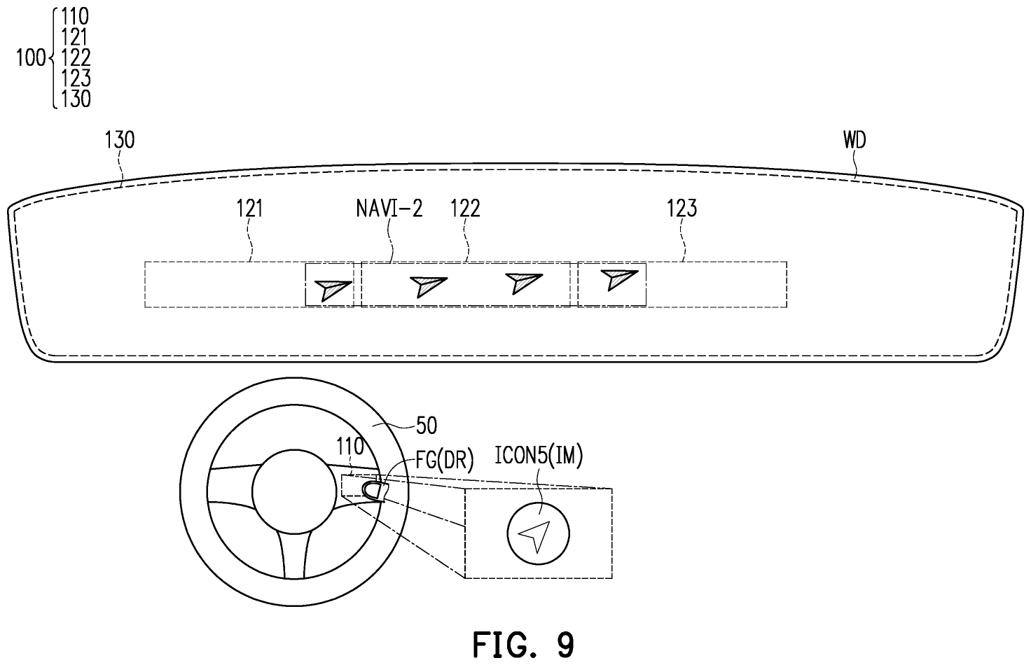

FIG. 7A to FIG. 7B are schematic views of the flow process of the cockpit display system in FIG. 1 operating in a third scenario. FIG. 8 is a schematic view of the cockpit display system in FIG. 1 operating in the third scenario. FIG. 9 is a schematic view of a variation implementation of FIG. 7B.

With reference to FIG. 2, FIG. 7A, and FIG. 7B, when the driver DR slides an icon ICON5 representing a navigation and instruction function to the center of the screen, the driver DR can perform the touch action of sliding the touch display 110 toward the head-up displays to enter the functional screen corresponding to the icon ICON5. In this functional scenario, the control unit 200 may display a navigation indicator NAVI-1 on the first head-up display 121 and the transparent display 130. More specifically, in the usage scenario of FIG. 7B, the first head-up display 121 and the transparent display 130 are adapted for displaying an image frame including the navigation indicator NAVI-1 in a tiled manner.

It is particularly noted that in order to enhance the immersive feeling that the displayed image brings to the driver DR, an imaging depth DT1 of each head-up display may be different from an imaging depth DT2 of the transparent display 130. With reference to FIG. 8, in this embodiment, the image screen of the navigation indicator NAVI-1 may be divided into a first portion NAVI-1a displayed on the first head-up display 121 and a second portion NAVI-1b displayed on the transparent display 130. The imaging depth DT1 of the first portion NAVI-1a is greater than the imaging depth DT2 of the second portion NAVI-1b.

From another point of view, in a vertical direction relative to the eyes EYE of the driver DR, since a depression angle difference is provided between the display positions of the first portion NAVI-1a and the second portion NAVI-1b of the navigation indicator NAVI-1 on the first head-up display 121 and the transparent display 130 respectively, the first portion NAVI-1a may be imaged far in front of the driver DR, while the second portion NAVI-1b is imaged close in front of the driver DR.

Nevertheless, the disclosure is not limited thereto. In another usage scenario, when the navigation system wants to remind the driver DR to turn right, the first head-up display 121, the second head-up display 122, and the third head-up display 123 may be used to display an image frame including a navigation indicator NAVI-2 in a tiled manner, as shown in FIG. 9.

When the driver DR wants to turn off the navigation function, the driver DR may use an operation method similar to FIG. 6B to slide the touch display 110 in the direction away from the head-up displays to exit the functional screen of the icon ICON5 and to re-enter the image screen IM of the functional menu.

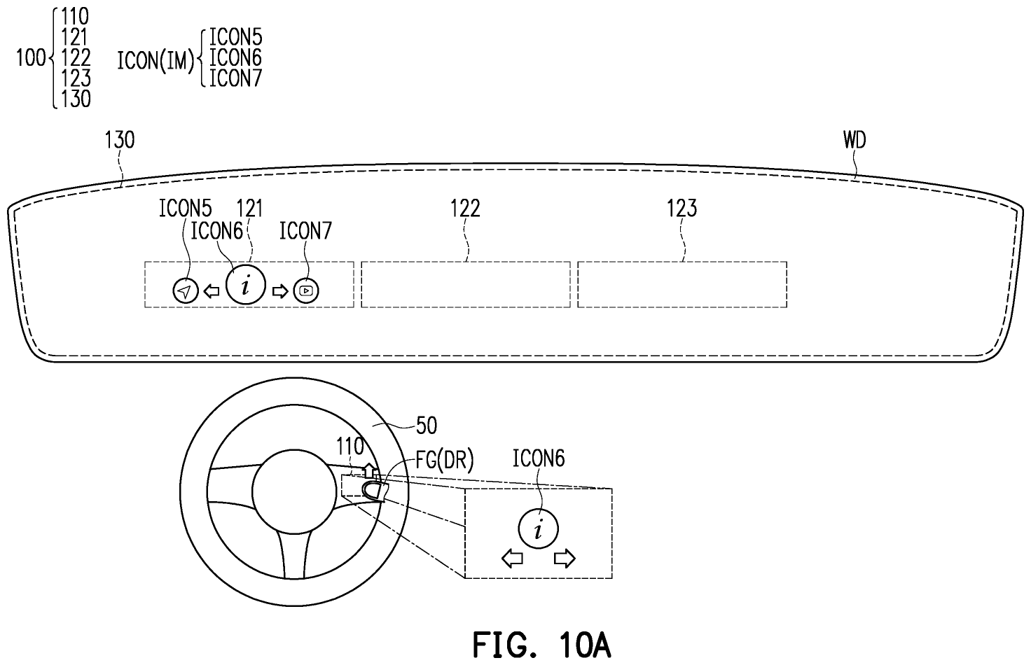

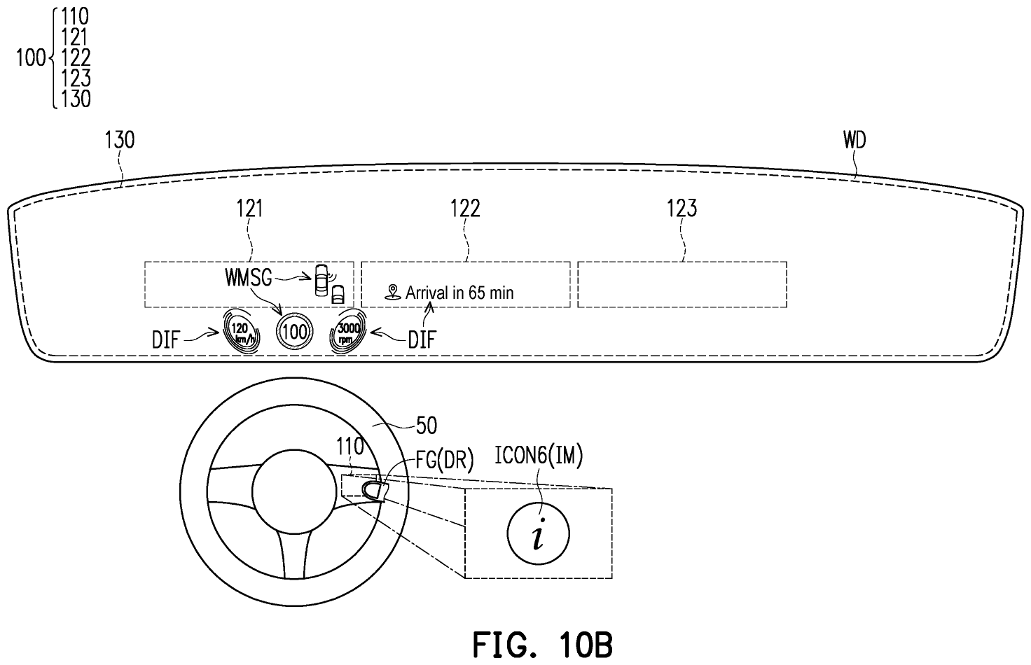

FIG. 10A to FIG. 10B are schematic views of the flow process of the cockpit display system in FIG. 1 operating in a fourth scenario. With reference to FIG. 2, FIG. 10A, and FIG. 10B, when the driver DR slides an icon ICON6 representing a driving information display function to the center of the screen, the driver DR can perform the touch action of sliding the touch display 110 toward the head-up displays to enter the functional screen corresponding to the icon ICON6. In this functional scenario, the control unit 200 may display driving information DIF and a warning message WMSG on the head-up displays and the transparent display 130.

In this embodiment, the driving information DIF includes, for example, the vehicle speed and engine speed displayed on the transparent display 130 and the estimated driving time displayed on the second head-up display 122. The warning message WMSG includes, for example, a vehicle approaching warning signal displayed on the first head-up display 121 and a vehicle speed limit of the driving section displayed on the second head-up display 122, but it is not limited thereto. When the driver DR wants to turn off the display function of the driving information, the driver DR may use an operation method similar to FIG. 6B to slide the touch display 110 in the direction away from the head-up displays to exit the functional screen of the icon ICON6 and to re-enter the image screen IM of the functional menu.

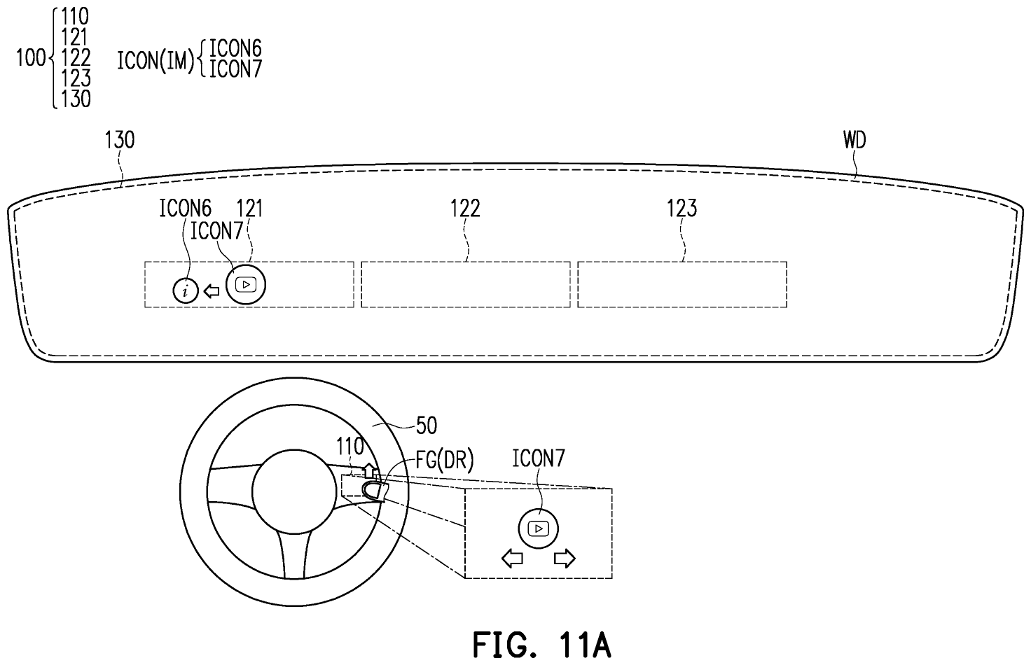

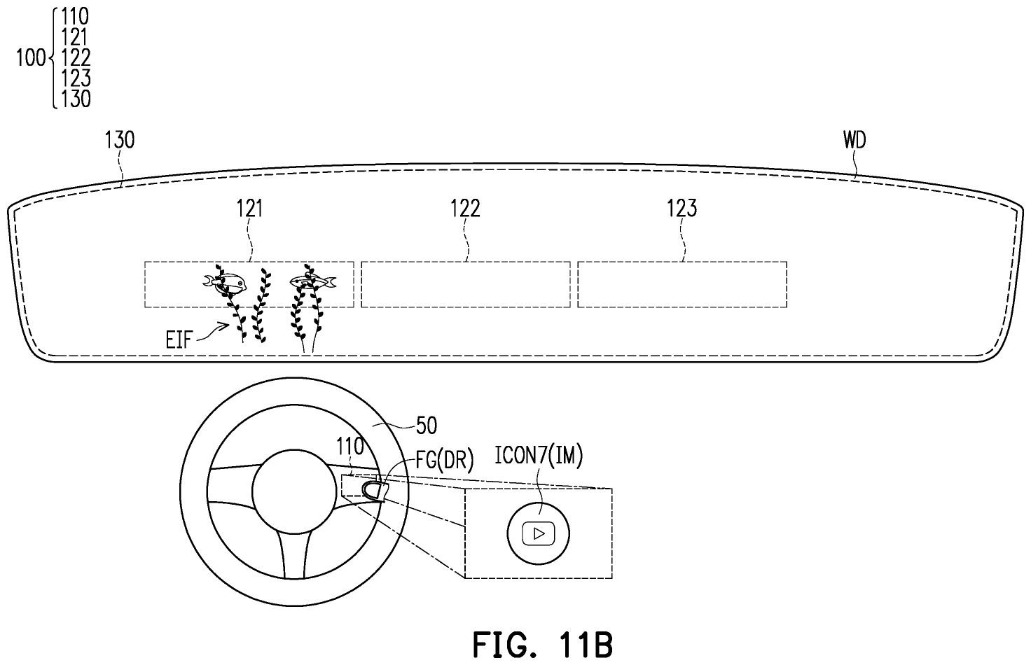

FIG. 11A to FIG. 11B are schematic views of the flow process of the cockpit display system in FIG. 1 operating in a fifth scenario. With reference to FIG. 2, FIG. 11A, and FIG. 11B, when the driver DR slides an icon ICON7 representing an entertainment function to the center of the screen, the driver DR can perform the touch action of sliding the touch display 110 toward the head-up displays to enter the functional screen corresponding to the icon ICON7. In this functional scenario, the control unit 200 may display entertainment information EIF on the head-up displays and the transparent display 130.

For instance, in this embodiment, the entertainment information EIF includes, for example, aquatic plants displayed on the transparent display 130 and fish displayed on the first head-up display 121. Similar to the usage scenario in FIG. 8, by using different imaging distances between the head-up displays and the transparent display 130, the content of the entertainment information EIF may exhibit a three-dimensional depth-of-field display effect, which helps to allow the driver DR to experience an improved immersive visual experience.

It is particularly noted that for the safety of the driver DR, the operation of this function can be limited to be executed only when the vehicle is stationary. For instance, only when the vehicle is stopped at a red light can the driver DR execute the function of display and operation of the entertainment information EIF. In order to remind the driver DR how long the driver DR has to wait before the traffic lights change, the cockpit display system 100 can also use an external camera or the vehicle-to-everything to obtain the countdown seconds of the traffic lights and display the countdown seconds on the touch display 110 (as shown in FIG. 6B) or the head-up display.

When the driver DR wants to turn off the entertainment function, the driver DR may use an operation method similar to FIG. 6B to slide the touch display 110 in the direction away from the head-up displays to exit the functional screen of the icon ICON7 and to re-enter the image screen IM of the functional menu.

In view of the foregoing, in the cockpit display system provided by an embodiment of the disclosure, the touch display installed in the steering wheel may be used to replace the multiple functional buttons on a currently-available steering wheel. Further, during operation, the control unit may display the image information on at least one of the touch display and the at least one head-up display according to the touch action performed on the touch display. In this way, the overall aesthetics of the steering wheel may be improved, and the selection and setting of its control items may be more intuitive and convenient.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A cockpit display system adapted to be installed in a cockpit, comprising:
a touch display disposed in a steering wheel in the cockpit and adapted to display image information, wherein a decorative layer of the steering wheel covers a display surface of the touch display;
at least one head-up display adapted for display on a see-through window of the cockpit; and
a control unit electrically connected to the touch display and the at least one head-up display, wherein the control unit is adapted to display the image information on at least one of the touch display and the at least one head-up display according to a touch action performed on the touch display.

2. The cockpit display system according to claim 1, wherein when the touch display is touched, the display surface of the touch display is adapted to be deformed and raised toward the decorative layer of the steering wheel.

3. The cockpit display system according to claim 1, wherein when the touch action is sliding in a direction of the at least one head-up display, the control unit displays the image information on the at least one head-up display.

4. The cockpit display system according to claim 3, wherein when the touch action is sliding in a direction away from the at least one head-up display, the control unit turns off the display of the image information on the at least one head-up display.

5. The cockpit display system according to claim 1, wherein the image information comprises a functional menu having a plurality of icons, the control unit is also adapted to switch and display the icons of the functional menu according to another touch action performed on the touch display, and the another touch action comprises sliding in an arrangement direction of the icons.

6. The cockpit display system according to claim 5, wherein the switching and displaying of the icons comprise enlarging a size of a focused one among the icons and maintaining or reducing the sizes of the remaining icons.

7. The cockpit display system according to claim 5, wherein the control unit is adapted to display a functional screen of the selected one among the icons on the at least one head-up display according to the touch action, and the touch action comprises sliding in a direction of the at least one head-up display.

8. The cockpit display system according to claim 7, wherein the touch action further comprises sliding in a direction away from the at least one head-up display.

9. The cockpit display system according to claim 1, further comprising:
a transparent display disposed in the see-through window of the cockpit and overlapping the at least one head-up display, wherein the image information is also adapted to be displayed on the transparent display.

10. The cockpit display system according to claim 9, wherein when the touch action is sliding in a direction of the at least one head-up display, the control unit displays the image information on the at least one head-up display and the transparent display.

11. The cockpit display system according to claim 10, wherein the at least one head-up display and the transparent display are adapted to display an image screen in a tiled manner.

12. The cockpit display system according to claim 9, wherein an imaging depth of the head-up display is different from an imaging depth of the transparent display.

13. A cockpit display system adapted to be installed in a cockpit, comprising:
at least one head-up display adapted for display on a see-through window of the cockpit;
a transparent display disposed in the see-through window of the cockpit and overlapping the at least one head-up display; and
a control unit electrically connected to the transparent display and the at least one head-up display and adapted to display an image frame on the transparent display and the at least one head-up display in a tiled manner.

14. The cockpit display system according to claim 13, further comprising:
a touch display disposed in a steering wheel in the cockpit and electrically connected to the control unit, wherein the control unit is adapted to display image information on the touch display according to a touch action performed on the touch display.

15. The cockpit display system according to claim 14, wherein a decorative layer of the steering wheel covers a display surface of the touch display.

16. The cockpit display system according to claim 15, wherein when the touch display is touched, the display surface of the touch display is adapted to be deformed and raised toward the decorative layer of the steering wheel.

17. The cockpit display system according to claim 14, wherein the image information comprises a functional menu having a plurality of icons, the control unit is also adapted to switch and display the icons of the functional menu according to another touch action performed on the touch display, and the another touch action comprises sliding in an arrangement direction of the icons.

18. The cockpit display system according to claim 17, wherein the control unit is also adapted to display a functional screen of the selected one among the icons on the at least one head-up display according to the touch action, and the touch action comprises sliding in a direction of the at least one head-up display.

19. The cockpit display system according to claim 18, wherein the touch action further comprises sliding in a direction away from the at least one head-up display.

20. The cockpit display system according to claim 13, wherein an imaging depth of the head-up display is different from an imaging depth of the transparent display.
